(19) United States
(12) Patent Application Publication
(10) Pub. No.: US 2025/0369999 A1
(43) Pub. Date: Dec. 4, 2025

(54) ULTRACOLD ATOM MEASURING SYSTEM AND ASSOCIATED METHOD

(71) Applicant: THALES, Meudon (FR)

(72) Inventors: Benjamin WIRTSCHAFTER, Palaiseau (FR); Matthieu DUPONT-NIVET, Palaiseau (FR); Soizic HELLO, Valence Cedex (FR)

(21) Appl. No.: 19/215,318

(22) Filed: May 22, 2025

(30) Foreign Application Priority Data
May 29, 2024 (FR) 2405537

(51) Int. Cl. G01P 15/08; G01C 19/64; G21K 1/00

(52) U.S. Cl. CPC G01P 15/08; G01C 19/64; G21K 1/003

(57) ABSTRACT

An ultracold atom measuring system, the measuring system including an assembly of ultracold atom inertial sensors, each sensor of the assembly being an interferometric sensor configured to measure a physical magnitude by implementing an interferometry sequence, a processing unit configured, for at least one sub-assembly of sensors, to apply a respective interferometry sequence to each sensor of a sub-assembly of sensors, the implementation of the respective interferometry sequences by the at least one sub-assembly of sensors causing the sensors of the sub-assembly to measure the same physical magnitude following a travel trajectory when displaced varying, from one sensor of the sub-assembly to another sensor of the sub-assembly, by at least one trajectory-related parameter.

### REFERENCE TO RELATED APPLICATION

This application is a U.S. non-provisional application claiming the benefit of French Patent Application No. 24 05539 filed on May 29, 2024, the contents of which are incorporated herein by reference in their entirety.

### TECHNICAL FIELD OF THE INVENTION

The present invention relates to an ultracold atom measuring system. The invention also relates to an associated measuring method.

The invention lies in the field of on-chip cold atom inertial sensors.

### BACKGROUND OF THE INVENTION

An inertial sensor is a device allowing measurement of physical parameters related to motion such as accelerations or angular velocity.

An on-chip cold atom inertial sensor is an interferometric sensor allowing measurement of a physical parameter to be obtained using an interferometric technique.

This allows inertial measurements of this type to be performed with sufficient compactness and performance for use in embedded applications.

The signal measured by interferometry is the population of each of the atomic states. With this measurement of population, it is possible to infer therefrom the phase obtained after interferometry, which itself is dependent upon the parameter to be measured, whether an acceleration or angular velocity.

However, the measured population signal is a pseudo-periodic signal as a function of polling frequency, which means that for a given population value there are corresponding different values of the parameter to be measured. This pseudo-periodic aspect therefore generates indeterminacy.

To lift this indeterminacy, it is known to hybridize the cold atom inertial sensor with a conventional inertial sensor.

This amounts to hybridizing a sensor having short-range measurement (cold atom sensor) with a sensor having long-range measurement (conventional sensor). The range of measurement is defined as the difference between the maximum value and minimum value of the physical magnitude to be measured (the mesurand), that it is possible to measure with the sensor.

Hybridization is obtained for example by using a vernier between the two sensors.

Another technique is deliberately to reduce the sensitivity of the inertial sensor to impose a measuring range that is relatively long-range allowing ambiguity to be lifted.

None of these techniques therefore provide both high sensitivity and long-range measurement.

There is therefore a need for a cold atom measuring system having both high sensitivity and long-range measurement.

### SUMMARY OF THE INVENTION

For this purpose, there is described an ultracold atom measuring system, the measuring system including:

an assembly of ultracold atom inertial sensors, each sensor of the assembly being an interferometric sensor configured to measure a physical magnitude using an interferometry sequence,
the implementing of the interferometry sequence causing the sensor to:
generate an initial trapping potential of a cloud of ultracold atoms,
spatially split the trapped cloud in the initial potential into a first cloud of ultracold atoms in a first state, and a second cloud of ultracold atoms in a second state through the respective forming of a first atom trap for the first cloud and a second atom trap for the second cloud, and
displacing the formed traps along a respective trajectory for the first cloud and second cloud,
   a processing unit configured, for at least one sub-assembly of sensors, to apply a respective interferometry sequence to each sensor of a sub-assembly of sensors, the implementing of the respective interferometry sequences by the at least one sub-assembly of sensors causing the sensors of the sub-assembly to measure the same physical magnitude along a trajectory when displaced varying, from one sensor of the sub-assembly to another sensor of the sub-assembly, by at least one parameter related to the trajectory.

According to other advantageous aspects of the invention, the measuring system includes one or more of the following characteristics taken alone or in any technically possible combination:
at least one sub-assembly of sensors is able to measure an acceleration, at least one parameter related to the trajectory being a separation distance between the two traps;
at least one sub-assembly of sensors is able to measure an acceleration, at least one parameter related to the trajectory being the trajectory travel time;
at least one sub-assembly of sensors is able to measure an angular velocity, at least one parameter related to the trajectory being the surface area delimited by the trajectory.
at least one sub-assembly of sensors is able to measure an angular velocity, at least one parameter related to the trajectory being the number of times the trajectory is travelled;
the assembly of sensors is formed on one same atomic chip placed in a vacuum chamber and including waveguides and conductive elements;
the measuring system additionally includes:
   an atom generating system configured to generate an initial cloud of ultracold atoms;
   a homogenous magnetic field generator;
   a powering device including at least one microwave generator and at least one direct current generator, the powering device being configured to apply microwave signals to the waveguides and direct currents to the conductive elements;
   the processing unit applying a respective interferometry sequence to each sensor of the at least one sub-assembly of sensors by controlling the homogenous magnetic field generator and the powering device;
the processing unit is able to apply a respective interferometry sequence to each sensor of several sub-assemblies of sensors, the implementing of the respective interferometry sequences by each sub-assembly of sensors causing the sensors of the sub-assembly to measure the same physical magnitude along a travel trajectory when displacing varying, from one sensor of the sub-assembly to another sensor of the sub-assembly, by at least one parameter related to the trajectory, the measured physical magnitude differing from one sub-assembly to another;
the number of sensors in a sub-assembly is between 2 and 30.

The description also describes a method to measure a physical magnitude with an ultracold atom measuring system, the measuring system including:

an assembly of ultracold atom inertial sensors, each sensor of the assembly being an interferometric sensor configured to measure a physical magnitude by implementing an interferometry sequence;
a processing unit;
the measuring method including:
a step by the processing unit, for at least one sub-assembly of sensors, to apply a respective interferometry sequence to each sensor of a sub-assembly of sensors,
the implementation of the respective interferometry sequence by the at least one sub-assembly of sensors causing the sensors of the sub-assembly to:
generate an initial trapping potential of a cloud of ultracold atoms,
spatially split the cloud trapped in the initial potential into a first cloud of ultracold atoms in a first state and a second cloud of ultracold atoms in a second state, by the respective forming of a first atom trap for the first cloud and a second atom trap for the second cloud;
displace the formed traps along a respective trajectory for the first cloud and second cloud; and
measure the same physical magnitude following a trajectory when displacing varying, from one sensor of the sub-assembly to another sensor of the sub-assembly, by at least one parameter related to the trajectory.

In the present description, the expression [symbol] able to [symbol] indifferently means [symbol] adapted for [symbol] , [symbol] adapted to [symbol] or [symbol] configured for [symbol] .

### BRIEF DESCRIPTION OF THE DRAWINGS

Characteristics and advantages of the invention will become apparent on reading the following description given solely as an example and nonlimiting, and with reference to the appended drawings in which:

FIG. 1 is a schematic illustration of a cold atom measuring system including inertial sensors formed on an atomic chip array;

FIG. 2 is a schematic illustration of an example of atomic chip allowing the obtaining of an ultracold atom accelerometer in the presence of an adapted interferometry sequence;

FIG. 3 illustrates the geometry of the guides and wires of the atomic chip in FIG. 2;

FIG. 4 is a schematic illustration of the trajectory taken by the atom clouds (part a in FIG. 4) at different times of implementation of an interferometry sequence adapted for the chip in FIG. 2 (chronogram of part b in FIG. 4);

FIG. 5 is a schematic illustration of an example of atomic chip allowing an ultracold atom gyroscope to be obtained, in the presence of an adapted interferometry sequence;

FIG. 6 illustrates the geometry of the guides and wires of the atomic chip in FIG. 5;

FIG. 7 is a schematic illustration of the trajectory of the atom clouds (part a in FIG. 7) at different times of implementation of an interferometry sequence adapted for the chip in FIG. 5 (chronogram of part b in FIG. 7);

FIG. 8 is a schematic illustration of another example of an atomic chip allowing an ultracold atom gyroscope to be obtained, in the presence of an adapted interferometry sequence;

FIG. 9 is a schematic illustration of the trajectory of the atom clouds at different times of implementation of an interferometry sequence adapted for the chip in FIG. 8;

FIG. 10 is a schematic illustration of the atomic chip array in FIG. 1 allowing the forming of inertial sensors;

FIG. 11 is a schematic illustration of another example of an atomic chip array allowing the forming of inertial sensors; and

FIG. 12 is a schematic illustration of the measuring system when in operation.

### DETAILED DESCRIPTION OF THE INVENTION

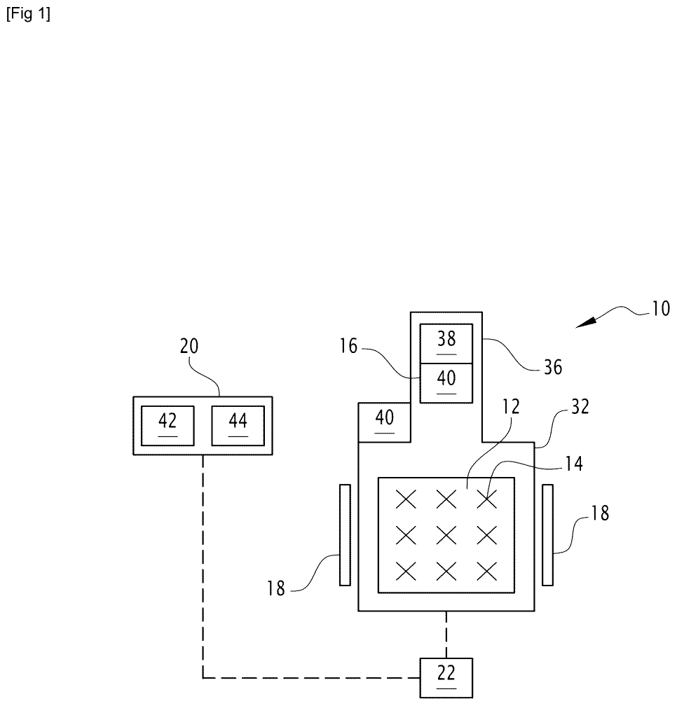

An ultracold atom measuring system 10 is schematically illustrated with reference to FIG. 1.

The measuring system 10 is able to measure one or more motion-related physical parameters such as accelerations or angular velocities which, when combined with a clock, allow localization in space.

If the measuring system 10 is able to measure acceleration and angular velocity, the measuring system is an inertial unit.

An inertial unit is sometimes designated by the acronym IMU standing for [symbol] Inertial Measurement Unit [symbol] .

It is considered herein that a measuring system 10 affording access to three separate values of acceleration or angular velocity along three different axes and non-colinear is an inertial unit.

Preferably, the measuring system 10 allows obtaining of the measurement of acceleration values along two different axes, and values of angular velocity along three different axes.

The measuring system is an ultracold atom measuring system.

Atoms are considered to be ultracold when their temperature is lower than 400 nanokelvins (nK), preferably lower than 300 nK.

The atoms used are alkaline atoms for example.

For the particular case in which the atoms are rubidium, in particular rubidium 87, the temperature of the atoms is between 50 nk and 400 nK, preferably between 100 nk and 300 nK.

The measuring system 10 includes an atomic chip 12 on which there is formed an assembly of inertial sensors 14.

The measuring system 10 includes an atom generating device 16, a generator 18 of a homogeneous magnetic field, a powering device 20 and a processing unit 22.

For good comprehension of the interaction between these different elements of the measuring system 10, it is first necessary to describe how to form an inertial sensor on an atomic chip.

Each inertial sensor is a device allowing measurement of motion-related physical parameters such as accelerations or angular velocities.

Each inertial sensor is an ultracold atom interferometric sensor.

Each sensor of the assembly is therefore configured to measure a physical magnitude by implementing an interferometry sequence.

Depending on the interferometry sequence applied to the inertial sensor, the functioning, i.e., the physical magnitude measured by the sensor, may differ.

An inertial sensor may therefore be perceived as a cold atom interferometer.

A description is now given of three particular sequences.

The first interferometry sequence described causes the inertial sensor to operate according to a first operating mode. The first operating mode is a clock operation and the measured physical magnitude is a frequency.

A cold atom interferometer causes two electron states of an atom to interfere in a Ramsey sequence.

The first state is denoted |a [symbol] and the second state is denoted |b [symbol] .

A Ramsey interferometry sequence is intended to measure a phase φ that is accumulated when the sequence is applied, from a measurement of at least one population of one of the states |a [symbol] or |b [symbol] .

Preferably, to increase accuracy, measurement of the phase φ is obtained from measurement of both populations.

In a Ramsey sequence of clock type, the phase output from the interferometer is given by:

$${φ}_{interf} = {φ}_{a} - {φ}_{b} = ( ω - {ω}_{ab} ) {T}_{R}$$

where:
   φ_{interf} is the phase output from the interferometer.
   φₐ is the phase of the atoms in the first state |a [symbol] ,
   φ_{b} is the phase of the atoms in the second state |b [symbol] .
   ω is the pulse of the local oscillator, the local oscillator typically being a microwave signal generator,
   ω_{ab} is the pulse corresponding to the difference in frequency between the first state |a [symbol] and second state |b [symbol] . The pulse ω_{ab} is therefore defined by ω_{ab}=ωₐ−ω_{b} where ℏωₐ designates the electron energy of the first state |a [symbol] (ℏ being Plack's reduced constant) and ℏω_{b} designates the electron energy of the second state |b [symbol] , and
   T_{R} is Ramsey time which is also the free-evolution time.

A second operating mode is an accelerometer functioning mode.

The interferometry sequence of the first operating mode is modified so that the atoms in the first state |a [symbol] and second state |b [symbol] each describe a rectilinear return trajectory starting from one same starting point, both trajectories and the starting point being aligned along a line denoted Dr.

With the interferometry sequence, acceleration-sensitive phase shifting occurs along the line Dr on account of the difference in potential acceleration energy between the two states |a [symbol] and |b [symbol] . This difference in potential acceleration energy corresponds to the fact that the energy levels of both states |a [symbol] et |b [symbol] were displaced with spatial separation of the two states.

The second interferometry sequence described causes the inertial sensor to operate in a second operating mode. The second operating mode is an accelerometer operating mode and the measured physical magnitude is an acceleration value along an axis.

It is assumed that separation takes place along the line Dr and that there is an acceleration during a separation time of the states. With this assumption, the phase output from the interferometer is written:

$${φ}_{interf} = ( ω - {ω}_{ab} ) {T}_{R} + \frac{m}{ℏ} {\int }_{O}^{{T}_{sep}} ac \cdot ( {x}_{a} ( t ) - {x}_{b} ( t ) ) dt$$

where:
   m designates the mass of the atom,
   Tₛₑₚ designates the duration of separation of the states, with

$${T}_{sep} \leq {T}_{R ′}$$

ac designates the value of acceleration occurring during the separation time,
xₐ(t) is the position of the atoms in the first state |a [symbol] along the line Dr, and
x_{b}(t) is the position of atoms in the second state |b [symbol] along the line Dr.

It may be considered that the separation and recombining times are negligible compared with the time the separation is maintained, i.e., the quantities Tₛₑₚ and T_{R} are substantially equal. With this assumption, the positions xₐ(t) and x_{b}(t) are no longer time-dependent.

This gives:

$${φ}_{interf} = ( ω - {ω}_{ab} ) {T}_{R} + \frac{m}{ℏ} ac \cdot Δ x \cdot {T}_{R}$$

where:
   Δx is the difference in position between the atoms in the two states, i.e., Δx=xₐ−x_{b}, where xₐ is the extreme position occupied by the first cloud and x_{b} is the extreme position occupied by the second cloud.

This expression may therefore be rewritten:

$${φ}_{interf} = \{ ω - ( {ω}_{ab} - \frac{m \cdot ac \cdot Δ x}{ℏ} ) \} {T}_{R}$$

Measurement of the phase output from the interferometer therefore provides access to the value of acceleration along the line Dr, the other parameters being known.

It also follows from this formula that the phase shift φ_{acc} caused by acceleration ac is written:

$${φ}_{acc} = \frac{m \cdot ac \cdot Δ x}{ℏ} {T}_{R}$$

The sensitivity S of the inertial sensor, which corresponds to the ratio between the output value and input value, is therefore given by the following formula:

$$S = \frac{m \cdot Δ x}{ℏ} {T}_{R}$$

The sensitivity S of the inertial sensor in the second operating mode may therefore be modified by varying the position difference Ax and free-evolution time T_{R}.

Therefore, to obtain operation in accelerometer mode, two return trajectories that are rectilinear and aligned must respectively be travelled by the two clouds of magnetically trapped atoms.

Displacement of the magnetic trap along the trajectories is obtained with conductive wires/elements and microwave guides arranged on and in an atomic chip.

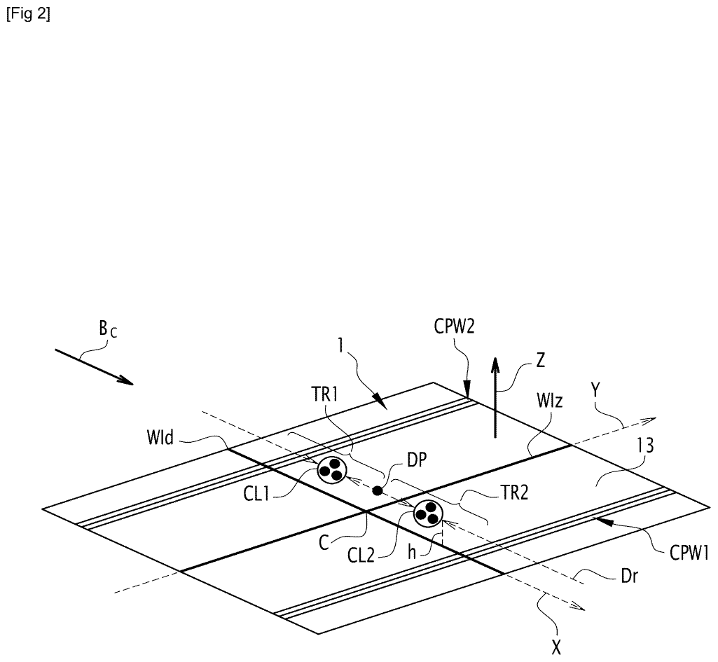

The arrangement for example may be the arrangement in FIG. 2.

The surface of the chip defines a plane XY or measurement plane 13, normal to an axis Z.

The chip 1 includes means adapted to generate a first ultracold atom trap T1 and a second ultracold atom trap T2, one trap allowing immobilization of a cloud of ultracold atoms in a state differing from the other trap, at a predetermined distance h from the measurement plane 13.

For example, trap T1 includes the atoms at the first electron level or first state |a [symbol] (cloud CL1) and trap T2 includes the atoms in the second state |b [symbol] (cloud CL2).

The levels corresponding to states |a [symbol] and |b [symbol] are spaced apart

$$\frac{{ω}_{ab}}{2 π} .$$

For example, for rubidium 87, these are two hyperfine levels |F=1, m_{F}=−1 [symbol] and |F=2, m_{F}=1 [symbol] , spaced apart by about 6.8 GHz.

These means also allow displacement of the clouds along trajectories TR1 and TR2 located in a plane parallel to the measurement plane 13, at a distancer h from this plane, as illustrated in FIG. 2.

A distance h therefore separates the plane of the trajectories and the measurement plane 13 of the chip.

The distance h is typically between 500 nanometers (nm) and 1 millimeter (mm), and preferably between 5 micrometers (μm) and 500 μm.

As may be seen in FIG. 2, these means a waveguides and conductive wires.

The waveguides CPW1 and CPW2 are adapted for propagation of microwaves at pulses ωₐ and ω_{b}.

The waveguides CPW1 and CPW2 are arranged symmetrically relative to an axis Y of the measurement plane, preferably parallel.

The two waveguides CPW1 and CPW2 are connected to at least one voltage or current generator at microwave frequency.

For example, each of the waveguides is formed by depositing three parallel conductive wires to form a coplanar waveguide.

In other embodiments, other types of waveguides are used, in particular waveguides having fabrication compatible with micro-fabrication techniques by depositing or etching.

For example, the waveguides are a microstrip.

The conductive wires integrated in the chip 1 are adapted to allow the passing of direct currents.

In the described example, the conductive wires are distributed

as a conductive wire WIz along an axis of symmetry Y perpendicular to X and contained within the measurement plane 13, and a conductive wire Wld parallel to axis X.

The wires are arranged such as to define a crossover point C (crossing between WIz and Wld) located on axis Y.

Each conductive wire is connected to one or more current and/or voltage generators themselves connected to a processing unit including at least one microprocessor.

The voltage and/or current generators allow guiding both of direct currents and alternating currents in the wires.

In particular, direct currents are guided into the conductive wires.

In the sensor under consideration, the atom chip 1 is placed in a vacuum chamber.

The vacuum is maintained by an ion pump for example.

The vacuum chamber preferably includes magnetic shielding.

The sensor here forming an accelerometer includes a device to generate ultracold atoms which includes:
an atom dispenser, formed for example of a heating filament delivering rubidium vapor;
a primary atom trap (optical and/or magnetic) to pre-cool and provide a cloud of ultracold atoms in the vicinity of the chip, to load the magnetic traps previously described with atoms.

The sensor also includes a magnetic field source, external to the chip 1.

With the magnetic field source, it is possible to impose a homogenous and stationary magnetic field Bc over a thickness at least of approximately height h above the measurement plane 13.

Advantageously, the direction of the homogeneous magnetic field Bc is parallel to the measurement plane.

In FIG. 2, the trajectories TR1 and TR2 in dotted lines respectively illustrate the trajectory of the clouds of ultracold atoms CL1 and CL2.

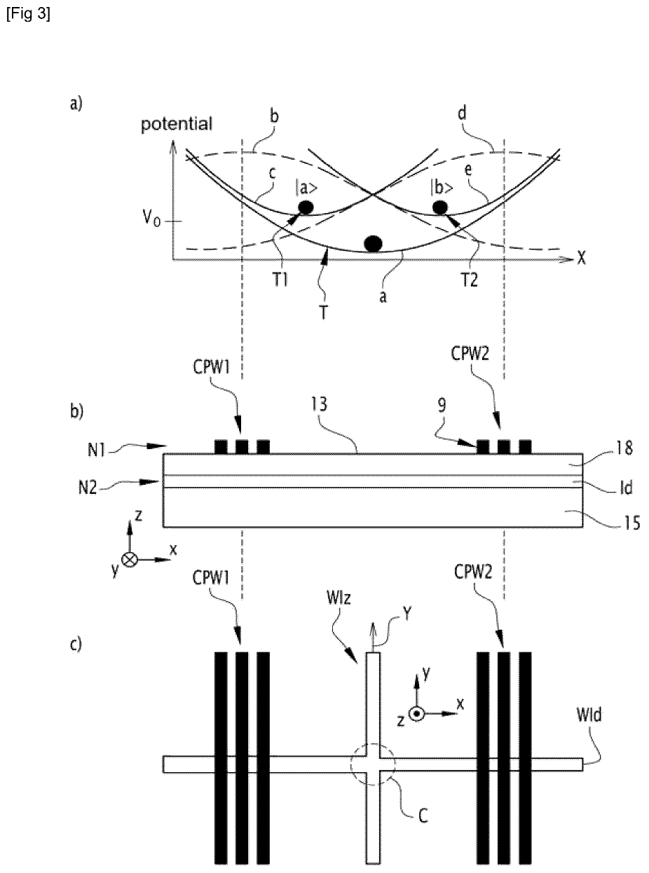

FIG. 3 more specifically illustrates the geometry of the guides and wires of the atomic chip, and the traps T1 and T2.

The specific arrangement of the conductive wires and waveguides, associated with the source of homogeneous magnetic field, easily allows obtaining of the two traps T1 and T2 as illustrated in part a) of FIG. 3.

Each trap T1 and T2 has a nonzero and identical minimum potential V0, and identical curvature for best functioning of the sensor. When a direct current is applied to the two conductive wires

crossing over at C, the potential minimum is located vertically above this crossover point. When a hyperfrequency power is subsequently sent into the waveguides, the central minimum is changed into two minima either side of the initial minimum in the direction of the waveguides.

If the initial minimum is not strictly located at equal distance from the two waveguides, the two created potential minima will not strictly have the same value of the minimum VO and the same curvature.

Part c) in FIG. 3 illustrates the arrangement of the conductive wires defining the initial crossover point C and of the waveguides (overhead view).

Part b) in FIG. 3 describes the corresponding arrangement of the conductive wires and waveguides printed on a chip in profile view, in cross-section along the conductive wire WId crossing over the conductive wire WIz along the axis of symmetry Y.

The waveguides CPW1 and CPW2 are coplanar waveguides located at a first level N1.

The insulating layer 18 advantageously allows planarizing of the measurement plane.

The material of the electrical insulating lawyer is silicon dioxide for example, silicon nitride or benzocyclobutene.

A conductive material is used for fabrication of the conductive wires, e.g., gold and is deposited on a substrate 15, forming a second level N2.

The substrate is in silicon for example, aluminium nitride or silicon carbide.

Part a) in FIG. 3 allows viewing of the symmetrical separation of ultracold atoms, specific to the internal state of ultracold atoms, and more specifically the variations in potentials as a function of axis X of the chip 1.

Curve [symbol] a [symbol] has a potential well corresponding to the association of the homogenous magnetic field with the field created by the two secant conductive wires, current I_{Z} passing though wire Wiz, and current I_{d} passing through wire WId.

A local potential well results therefrom, the initial potential Vini forming an atom trap T in three dimensions. A cloud of ultracold atoms may be trapped therein and cooled.

Curve [symbol] b [symbol] schematically shows the potential created by transmission of microwaves at pulse ω_{b} into the waveguide CPW1.

The field emitted by passing of microwaves at pulse ω_{b} allows the energy of the ultracold atoms to be modified, and displacement of the atoms in the second state |b [symbol] .

Curve [symbol] e [symbol] illustrates the potential seen by the atoms in the second state |b [symbol] further to contributions of the potentials illustrated by curve [symbol] a [symbol] and curve [symbol] b [symbol] .

Curve [symbol] e [symbol] shows a local potential minimum allowing the local trapping of a cloud of ultracold atoms in the second state |b [symbol] .

Similarly, curve [symbol] d [symbol] schematically shows the potential created by the transmission of microwaves at pulse ωₐ into the waveguides CPW2. The field emitted by the passing of microwaves at pulse ωₐ allows the energy of the ultracold atoms to be modified and displacement of the atoms in the first state |a [symbol] .

Curve [symbol] c [symbol] illustrates the potential seen by the atoms in the first state |a [symbol] further to contributions of the potentials illustrated by curve [symbol] a [symbol] and curve [symbol] d [symbol] .

Curve [symbol] c [symbol] shows a local energy minimum allowing the local trapping of a cloud of ultracold atoms in the first state |a [symbol] .

The association of a magnetic trap DC (created by direct currents in the wires and the homogeneous field Bc) with a microwave field creates a [symbol] dressed-state [symbol] trap.

A [symbol] dressed-state [symbol] trap is a trap at least partly created by an oscillating microwave field, radiofrequency or optical.

The changes of the microwave fields (power, frequency and guide in which the fields are propagated) allow this dressed-state trap to be displaced and therefore displacement of the atoms.

The magnetic trap DC is illustrated in FIG. 3 by curve a. The microwave field at pulse ωₐ is illustrated in FIG. 3 by curve d and the microwave field at pulse ω_{b} is illustrated in FIG. 3 by curve b. The dressed-state trap T1 (association of curves a and d) for the first state |a [symbol] is illustrated by curve c, and the dressed-state trap T2 (association of curves a and b) for the second state |b [symbol] is represented by curve e.

The clouds of ultracold atoms in states |a [symbol] and |b [symbol] may be separated and trapped symmetrically relative to the axis of symmetry Y by simultaneously imposing propagation of waves of pulse ωₐ into waveguides CPW2 and of pulse ω_{b} into waveguides CPW1.

To obtain two traps having minima of same value V0 and having curvatures of same value, it is desirable that the crossover point C should be equally distant from the waveguides CPW1 and CPW2, on the axis of symmetry Y.

The pulses ωₐ and ω_{b} are chosen as a function of the energies of the two states |a [symbol] and |b [symbol] .

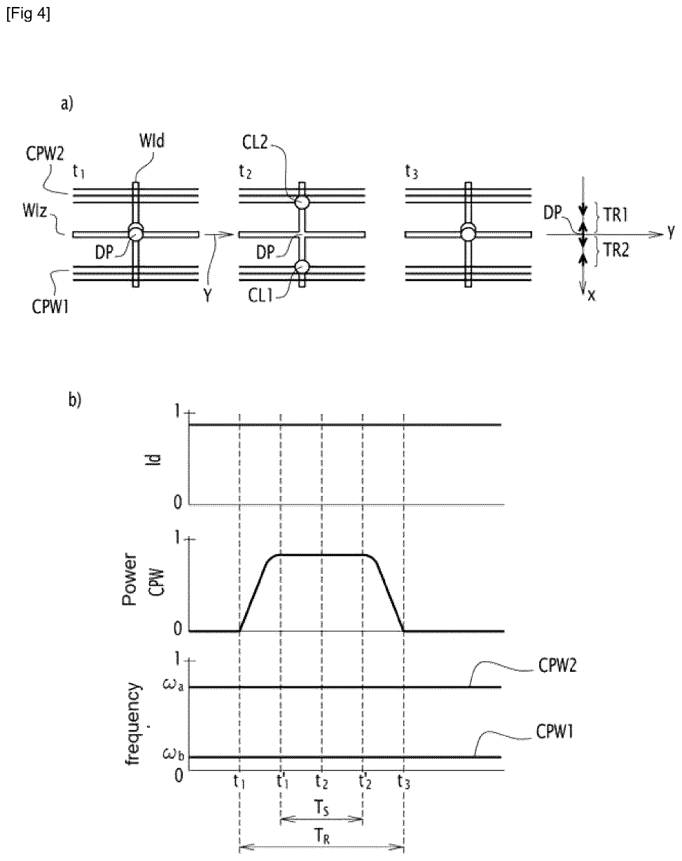

FIG. 4 in the lower part b) illustrates an example of application of different signals to the wires and guides so that, for a sensor operating as an accelerometer, the linear trajectories are caused to lead to the two traps T1 and T2 (and hence to the two clouds of trapped atoms), and in the upper part a) the position is shown of the two clouds corresponding to chosen times.

Part a) in FIG. 4 therefore schematically illustrates a displacement sequence of each of the clouds of ultracold atoms at characteristic times t₁ to t₃.

Part b) illustrates the sequence of the different currents applied

to the conductive wires, powers applied to the waveguides and frequencies imposed on the waveguides, for the times corresponding to those of part a).

In the sequence shown in FIG. 4, the current I_{z}, not illustrated, circulating in WIz is stationary at a constant value.

The current applied to WId is also constant throughout the entire sequence.

The interferometry sequence includes a plurality of steps A0 to F0 which will now be described.

At step A0, there is a preparation phase of the atoms. A cloud of ultracold atoms is generated in particular by performing an emission step of the atoms, a cooling step of the atoms, an initialization step of the atoms in at least one of states |a [symbol] and |b [symbol] , and a trapping step of a cloud of the ultracold atoms in a local potential minimum at a distance h from the measurement plane (trap T, curve [symbol] a [symbol] in FIG. 3 part a)).

The height h differs from 0 since the homogeneous magnetic field Bc is nonzero.

Trapping is obtained by applying direct currents to wire WIz and wire WId, and by superimposing thereupon a bias magnetic field Bc parallel to the plane of the atomic chip (generation of Vini).

The cloud of atoms is then trapped by the Vini potential vertically to C, intersection of wires Wlz and Wld.

This step A0 takes place between 0 and time t₁ in FIG. 4 part b).

At step B0, the states of the atoms are initialized by coherently superimposing the ultracold atoms between states |a [symbol] and |b [symbol] , with a first pulse π/2.

The first pulse π/2, depending on embodiments, is performed by laser, microwave emission or more generally a technique emitting waves at an adapted transition frequency.

Currents I_{Z} and I_{d} are respectively imposed upon the conductive wires WIz and WId.

The two states |a [symbol] and |b [symbol] are superimposed coherently and spatially, vertically aligned with the crossover point C.

At step C0, the initial cloud is separated into a first cloud of ultracold atoms CL1 in the first state |a [symbol] and a second cloud of ultracold atoms CL2 in the second state |b [symbol] , forming a first ultracold atom trap T1 and a second trap T2.

This step C0 is illustrated by the part between times t₁ and t′₁ in FIG. 4 part b).

At step D0, the separation of the two traps is maintained for a time T_{S} (between times t′₁ to t′₂) after which the traps are recombined at the starting point (between times t′₂ and t₃).

At steps C₀ and D_{0,} the two clouds respectively travel over a first trajectory TR1 and a second trajectory TR2, both linear and parallel to plane XY from the starting point DP.

At step E0, the two states |a [symbol] and |b [symbol] are recombined by applying a second pulse π/2 to the ultracold atoms.

The second pulse π/2 transfers the phase difference onto the populations of the two atom levels.

The pulses π/2 may be sent to the atoms via the microwave guides or via a separate microwave emitter.

The sequence ranging from the first pulse π/2 to the second pulse π/2 included is the Ramsey sequence.

Thereafter, at step F0, the output phase particularly including a contribution of the difference in potential acceleration energy between the two states |a [symbol] and |b [symbol] of the ultracold atoms is measured and the acceleration of the sensor along axis X is calculated.

Considering solely the Ramsey sequence of duration T_{R} between times t₁ and t₃, at the start at time t₁ no power is applied to the waveguides and the cloud is trapped above point C.

Between times t₁ and t′₁, the microwave power injected into the waveguides CPW1 and CPW2, progressively changes from 0 to its maximum value, after which the value remains maximal and constant between times t′₁ and t′₂ passing through time t₂. A microwave of pulse ωₐ is sent into the waveguide CPW2 and another at pulse ω_{b} is sent into the waveguide CPW1, which allows separating of the two clouds of different internal states either side of the axis of symmetry Y and as far as the positions schematized at time t₂, these positions being maintained throughout the whole time interval between time t′₁ and t′₂, which may be short.

Between times t′₂ and t₃, the microwave power in the waveguides is gradually cut off. The two traps T1 and T2 are displaced until they merge into a single trap located at the starting point schematized at time t₃ (part a)).

The third interferometry sequence described causes the inertial sensor to function according to a third operating mode. The third operating mode is that of a gyroscope and the physical magnitude measured is a value of angular velocity along an axis.

The interferometry sequence of the first operating mode is modified so that the atoms in the first state |a [symbol] and in the second state |b [symbol] each follow the same closed trajectory containing a nonzero surface area, but travelled in opposite directions.

With the sequence, a phase shift occurs sensitive to rotations along the normal to the surface including the trajectory, with the Sagnac effect. This corresponds to gyroscope functioning.

More specifically, if the trajectory followed by the atoms in the first state |a [symbol] is travelled in clockwise direction, then the trajectory followed by the atoms in the second state |b [symbol] is travelled in anti-clockwise direction, the phase shift is written:

$${φ}_{interf} = ( ω - {ω}_{ab} ) {T}_{R} + \frac{m}{ℏ} {\int }_{O}^{{T}_{R}} [ {Ω}_{z} ( {r}_{a} ∧ {v}_{a} ) + {( {Ω}_{z} ∧ {r}_{a} )}^{2} + a \cdot {r}_{a} ] dt - \frac{m}{ℏ} {\int }_{O}^{{T}_{R}} [ {Ω}_{z} ( {r}_{b} ∧ {v}_{b} ) + {( {Ω}_{z} ∧ {r}_{b} )}^{2} + a \cdot {r}_{b} ] dt$$

where:
   Ω_{z} is the angular velocity about an z, axis z being an axis perpendicular to the plane of the trajectory,
   rₐ designates the position of the atoms in the first state |a [symbol] in a reference frame fixed to the sensor,
   vₐ designates the velocity of the atoms in the first state |a [symbol] in the reference frame fixed to the sensor,
   a designates the acceleration undergone by the sensor, this acceleration being directed along a separation axis of the two states,
   r_{b} designates the position of the atoms in the second state |b [symbol] in the reference frame fixed to the sensor, and
   v_{b} designates the velocity of the atoms in the second state |b [symbol] in the reference frame fixed to the sensor.

For a trajectory forming a loop, where each state returns to its initial position at the end of the sequence, it may be shown that if acceleration a is constant, the terms a. rₐ and a.r_{b} equal 0 and the terms (Ω_{z}∧rₐ)² and (Ω_{z}∧r_{b})² cancel each other.

Assuming that the angular velocity Ω_{z} is constant during free-evolution time T_{R}, the phase output from the interferometer is then written:

$${φ}_{interf} = ( ω - {ω}_{ab} ) {T}_{R} + \frac{4 m {Ω}_{z} \cdot AN}{ℏ} {T}_{R}$$

$$i . e . ,$$

$${φ}_{interf} = ( ω - {ω}_{ab} + \frac{4 m {Ω}_{z} \cdot AN}{ℏ} ) {T}_{R}$$

where:
   A is a vector normal to the surface followed by the trajectories of the two states and having a norm equal to the surface area delimited by the trajectories, and
   N is the number of turns (closed loops) travelled by the atoms during time T_{R}.

Measurement of the phase output from the interferometer therefore provides access to the value of rotational speed along axis z, the other parameters being known.

It also follows from this formula that the phase shift φᵣₒₜ caused by rotation along axis z is written:

$${φ}_{rot} = \frac{4 m {Ω}_{z} \cdot AN}{ℏ} {T}_{R}$$

The sensitivity S of the inertial sensor which corresponds to the ratio between the output value and input value is therefore given by the following formula:

$$S = \frac{4 mAN}{ℏ} {T}_{R}$$

The sensitivity S of the inertial sensor in the third operating mode may therefore be modified by varying the area ∥A∥ of the space delimited by the trajectories, the number of turns N and free-evolution time T_{R}.

Therefore, to obtain gyroscope functioning, a trajectory must be taken travelled in contra-propagating manner by two clouds of magnetically trapped atoms.

The forming and displacement of the magnetic trap along the trajectory are obtained by conductive wires/elements and microwave guides arranged on and in the atomic chip.

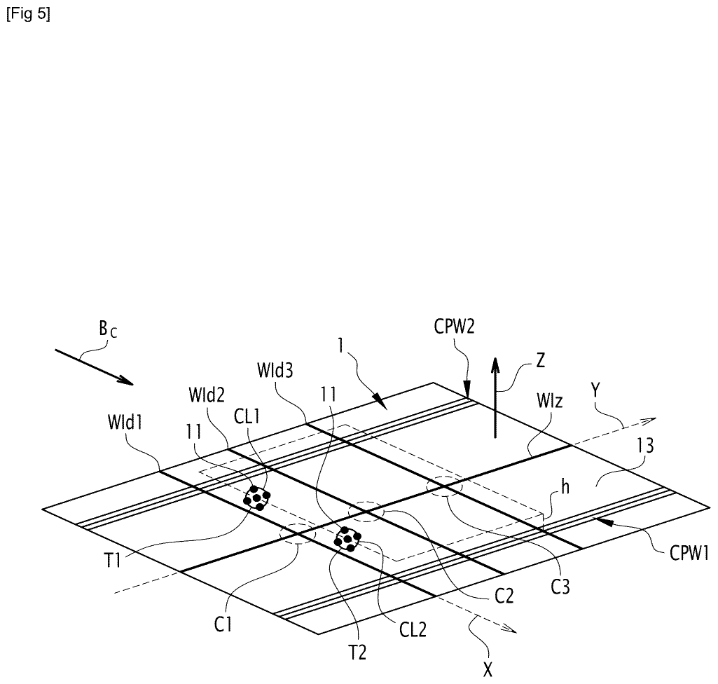

The arrangement is the arrangement in FIG. 5 for example.

The described arrangement is fairly similar to the one described with reference to FIG. 2, similar remarks therefore apply for corresponding elements.

Soley the differences are described below.

Instead of a conductive wire Wld, the chip 1 here includes a plurality of conductive wires.

The conductive wires are distributed between the conductive wire WIz along an axis of symmetry Y perpendicular to X and contained within the measurement plane 13, and a plurality of n conductive wires Wldi, the index i varying from 1 to n, parallel to each other and parallel to axis X, n at least equaling 2.

In the example in FIG. 1, n=3 which indicates the presence of three conductive wires WId1, WId2 and WId3.

The wires are arranged to define n crossover points Ci (crossing of WIz and Wldi) located on axis Y, here 3 crossover points C1, C2, C3.

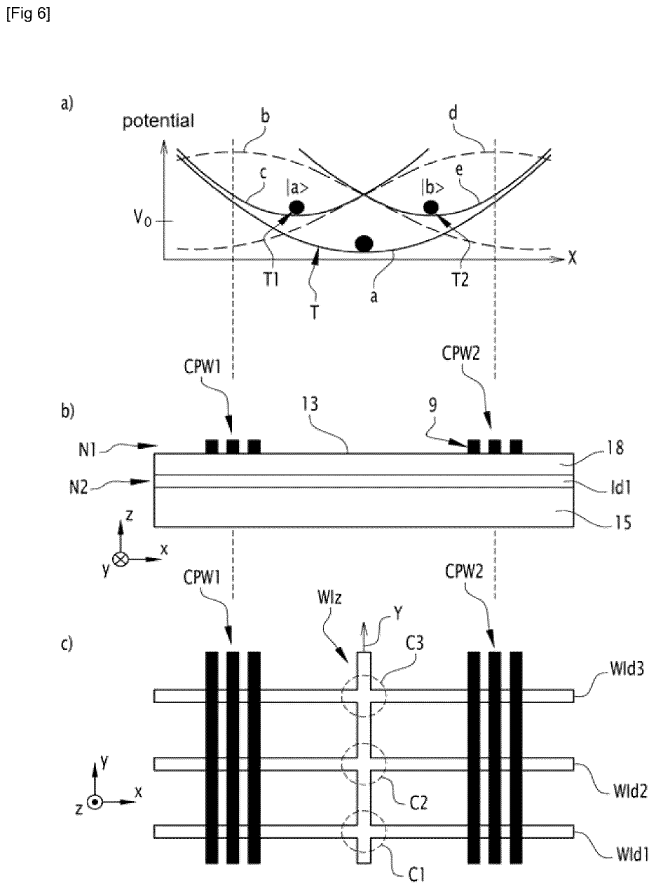

In FIG. 6, the trajectory of |a [symbol] differs from that of |b [symbol] and defines an area denoted A.

FIG. 6 corresponds to FIG. 3 for the first conductive wire WId1. The same remarks therefore apply and will not be repeated.

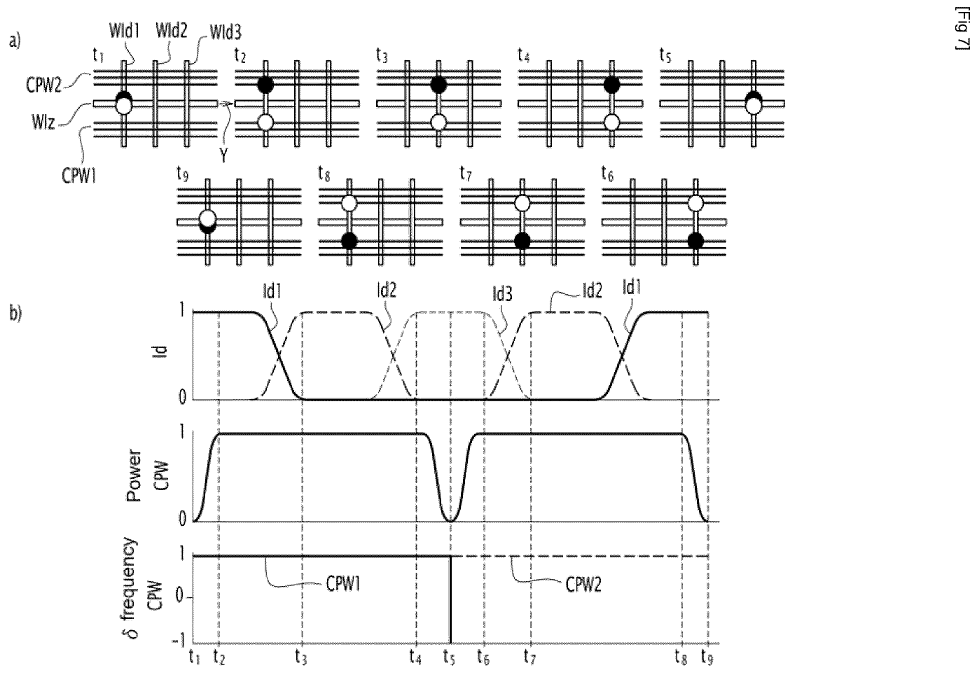

FIG. 7 illustrates the sequence allowing generation of trajectory 16.

Part a) in FIG. 7 schematically illustrates a displacement sequence of each of the clouds of ultracold atoms, at characteristic times t₁ to t₉.

Part b) is a supplemental illustration showing a sequence of the different currents applied to the conductive wires, the powers applied to the waveguides and frequencies imposed upon the waveguides, at times corresponding to those of part a).

In the sequence shown in FIG. 7, the current I_{z}, not illustrated, circulating in WIz is stationary at a constant value. In part b), the values of currents, powers and frequencies are arbitrary.

The δ frequency on the Y-axis corresponds to a variation in frequency expressed in arbitrary units around a mean value of the frequency.

The currents passing through the conductive wires may be between 100 μA and 10 A, and the pulses injected into the waveguides may be between 6.6 GHz and 7 GHz in the event rubidium atoms are used.

The interferometry sequence includes a plurality of steps A0 to E0 which will now be described.

At step A0, the atoms are prepared and a cloud of ultracold atoms 11 is generated. Step A0 includes a step to emit the atoms, a cooling step of the atoms, an initialization step of the atoms in at least one state |a [symbol] and a trapping step of a cloud of the ultracold atoms in a local potential minimum at a distance h from the measurement plane (trap T, curve [symbol] a [symbol] in FIG. 6 part a)).

Trapping is obtained by passing direct currents into wire WIz and one of the WIdi wires, the crossover point of these two wires defining the starting point (here C1 with WId1).

A bias magnetic field Bc parallel to the plane of the atomic chip,

superimposing itself over the magnetic field created by the two previous wires, is simultaneously applied. The cloud of atoms is then trapped by the potential Vini vertical to C1 the intersection of wires Wlz and Wld1.

At step B0, the states are initialized by coherent superimposition of the ultracold atoms between states |a [symbol] and |b [symbol] , by a first pulse π/2.

The first pulse π/2 may be applied by laser, microwave emission or more generally by a technique emitting waves at an adapted transition frequency.

The currents I_{Z} and I_{d1} are respectively imposed upon the conductive wires WIz and WId1.

The two states |a [symbol] and |b [symbol] are coherently and spatially superimposed, vertically aligned with the crossover point C1.

At step C0, a cloud of atoms in the first state |a [symbol] in a trap T1 is spatially separated from a cloud of atoms in the second state |b [symbol] in another trap T2.

The traps are displaced in opposite direction along a closed trajectory contained in a plane perpendicular to the measurement axis Z.

The cloud of atoms in the first state |a [symbol] is symbolized by a disc of light texture and the cloud of atoms in the second state |b [symbol] is symbolized by a disc of darker texture.

This step C0, in the example in FIG. 7, is implemented starting from time t₁ up to time t₉.

Between times t₁ and t₂, the microwave power injected into the waveguides CPW1 and CPW2, progressively changes from 0 to its maximum value.

A microwave at pulse ω_{b} is sent into the waveguide CPW1 and another pulse ωₐ is sent into the waveguide CPW2, which allows separating of the two clouds of different internal states either side of the axis of symmetry Y, by a distance d, as far as the positions schematized at time t₂.

The ultracold atom trap T previously described at time t₁ is then changed into two ultracold atom traps T1 and T2, each trap allowing immobilization a cloud of ultracold atoms of internal state differing from the other trap (here in the first state |a [symbol] in one of the traps, e.g., T1, and in the second state |b [symbol] in the other trap T2, as described in part a) in FIG. 7)

A crossover point Ci corresponds to the crossing of wire WIz with wire WIdi.

Between times t₂ and t₃, the current I_{d1} is progressively cut off and I_{d2} is progressively brought to its maximum value (the time interval separating times t₂ and t₃ is typically in the region of 10 ms and may be between 0.1 ms and 100 ms): the two traps T1 and T2 are displaced towards the right as far as the positions schematized at time t₃.

Between times t₃ and t₄, the current I_{d2} is progressively cut off and the current I_{d3} is progressively brought to its maximum value: the two traps are displaced towards the right as far as the positions schematized at time t₄.

Between times t₄ and t₅, the microwave power is progressively cut off: the two traps are returned to the same point on the chip schematized at time t₅.

At time t₅, the pulses applied to the two waveguides are modified: a microwave at pulse ωₐ is imposed upon CPW1 and another of pulse ω_{b} is imposed upon CPW2.

Between times t₅ and t₆, the power in the two waveguides progressively changes from 0 to its maximum value: the traps are separated in the vertical direction as schematized at time t₆.

Between times t₆ and t₇, the current I_{d3} is progressively cut off and the current I_{d2} is progressively brought to its maximum value: the two traps T1 and T2 are displaced towards the left as far as the positions schematized at time t₇.

Between times t₇ and t₈, the current I_{d2} is progressively cut off and the current I_{d1} is progressively brought to its maximum value: the two traps are displaced towards the left as far as the positions schematized at time t₈.

This operation may be repeated several times with other first conductive wires to increase the area contained within the trajectory.

Between times t₈ and t₉, the microwave power in the waveguides is progressively cut off. The two traps T1 and T2 are displaced until they merge into a single trap located at the starting point schematized at time t₁.

Direct currents are therefore applied to the two wires corresponding to the initial crossover point C1, and over time these currents are successively applied to the different crossover points Ci located on the axis of symmetry Y by simultaneously applying a microwave power to the waveguides.

At step C0, the different currents applied to the different wires WIdi vary continuously (increase and decrease) between 0 and a maximum value Idimax (normalized at 1 in FIG. 7), whilst the magnetic field Bc and current I remain constant throughout the sequence.

At all the steps A0, B0 and C0, the two traps T1 and T2 remain at altitude h.

The two traps T1 and T2 are displaced in the direction of [symbol] firing [symbol] of the crossover points: from crossover point C1 toward crossover point Cn.

The return takes place by reversing the microwave frequencies and switching on the direct currents successively in the corresponding wires at the different crossover points, passing from Cn to C1.

The traps therefore travel over the closed trajectory.

At a step D0, the states |a [symbol] and |b [symbol] are recombined by applying a second pulse π/2 to the ultracold atoms.

The second pulse π/2 transfers the phase difference onto the populations of the two atomic levels.

The pulses π/2 may be sent to the atoms via the waveguides or via a separate microwave emitter.

The sequence extending from the first pulse π/2 to the second pulse π/2 included is the Ramsey sequence.

The number of atoms in a state chosen from among at least the states |a [symbol] and |b [symbol] is then measured.

Finally, at step E0, the Sagnac phase of the ultracold atoms (interferometry phase) is determined and the rotational speed of the sensor along axis Z is calculated.

To measure a rotational speed along an axis, a trajectory must be generated in a plane perpendicular to this axis.

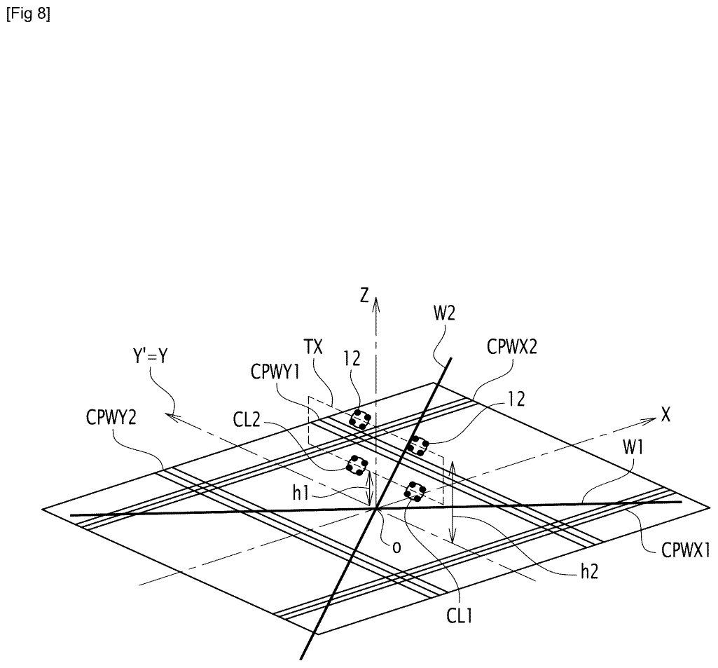

A second example of chip topology is illustrated in FIG. 8.

The atomic chip includes a first pair of waveguides CPWX1 and CPWX2 parallel to each other and arranged symmetrically relative to axis X, and a second pair of waveguides CPWY′1, CPWY′2 parallel to each other and arranged symmetrically relative to axis Y′.

In this nonlimiting example, the axis Y′ is perpendicular to X and equal to axis Y.

Since axis Y′ differs from axis X, the two pairs of guides are secant and define a parallelogram.

The chip also includes two conductive wires W1 and W2 which cross over each other at point O.

When a direct current passes through the two conductive wires W1 and W2, they generate the potential Vini which has a minimum at point O.

The starting cloud CL is thus trapped above point O.

For reasons of symmetry, point O preferably merges with the center of the parallelogram.

In this example, trajectories perpendicular to X (trajectory TX) and Y (trajectories TY) are formed.

To measure the rotational speed Ωx along axis X, the trajectory TX is generated via the waveguides, conductive wires and field Bc.

Similarly, to measure the rotational speed Ωy′ along axis Y′, a trajectory TY′ is generated via the waveguides, conductive wires and field Bc.

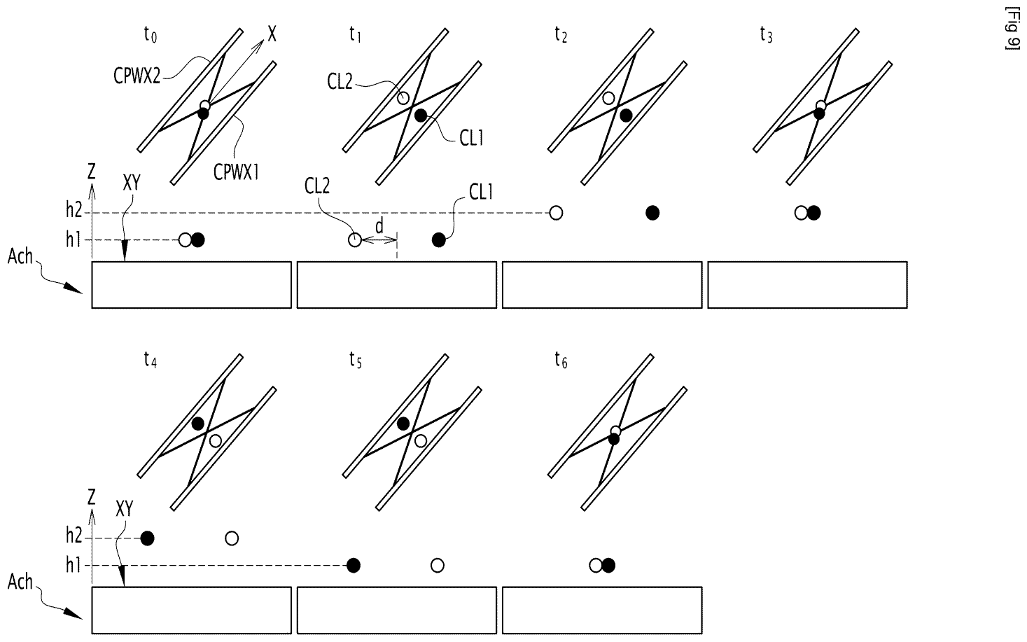

The trajectory of the atoms to form trajectory TX is illustrated in FIG. 9. The Ramsey sequence starts at time t₀ (direct currents are applied to the two conductive wires W1 and W2, to generate Vini).

At time t₁, the clouds are separated, the separation of the two clouds taking place in the same manner as in the previously described technique (application of microwave signals to the guides).

At time t₂, the clouds CL1 and CL2 are displaced from a height h1 towards a height h2 by modifying the value of the current circulating in the wires and/or by modifying the value of the field Bc.

A substantially vertical portion of the trajectory is therefore travelled over a distance w=h2−h1.

Next, at time t3, the two clouds are returned to axis X still at height h2 by progressive decrease until cancellation of the power applied to the waveguides.

The other part of the second trajectory portion at h2 on the other side of the axis X (times t₄ and t₅) is obtained by inverting the values of the microwave frequencies applied to the guides CPWX1 and CPWX2.

Descent back to height h1 is then obtained by a return to the initial values of the currents circulating in the conductive wires and/or to the initial value of the magnetic field.

The two clouds finally join up at time to by cancelling the microwave power applied to the guides.

The geometries of the chips in FIGS. 5 and 8 may be combined by integrating additional wires defining crossover points inside the parallelogram defined by the guides.

This gives an interferometric inertial sensor allowing measurement of the three rotational speeds Ωx, Ωy and Ωz.

Returning to FIG. 1, the role of each of the different elements of the measuring system 10 will now be described.

The atomic chip 12 is a chip on which there is formed the assembly of inertial sensors 14.

In the example in FIG. 1, the assembly of inertial sensors 14 is arranged on the chip 12 in an array.

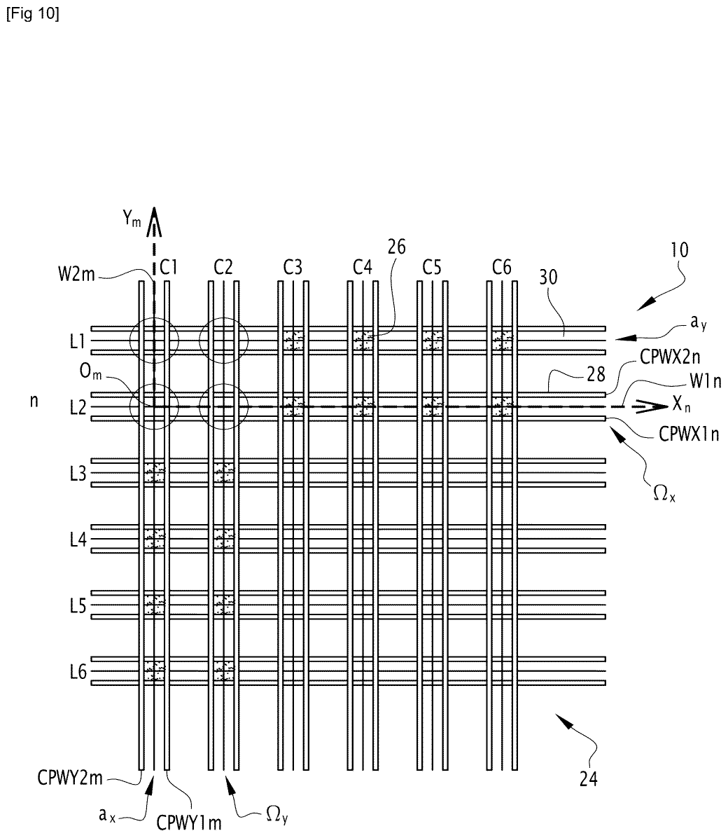

The chip 12 may be more specifically seen in FIG. 10.

In this example, the chip 12 is an array 24 of elementary chips 26. In the example, the array 24 is a 6×6 array.

Each elementary chip 26 is formed according to the preceding examples, and in this respect, they include waveguides 28 and conductive wires 30.

The waveguides 28, along 6 axes Xn and along 6 axes Ym, form the columns and rows of the array.

Each elementary chip 26 of the array 24 corresponds to a potential elementary inertial sensor 14 which may be configured as a function of needs by a suitable interferometry sequence and may be identified by a doublet (n, m) where n is an integer designating the row to which the elementary chip 26 belongs, and m is an integer designating the column to which the elementary chip 26 belongs.

For example, the elementary chips 26 of column C1 measure acceleration ax along X, the elementary chips 26 in column C2 measure the rotational speed Ωy about axis Y, the elementary chips 26 in row L1 measure acceleration ay along Y, and the elementary chips 26 in row L2 measure the rotational speed Ωx about axis X.

Since a measurement involves a particular sequence for the coplanar guides 28, these guides cannot be shared for two simultaneous measurements of two different inertial parameters.

Therefore, the encircled elementary chips 26 are not used.

The chip array 12 is therefore reconfigured according to needs: the type of desired measurement (ax, ay, Ωx, Ωy, t), the desired accuracy (a function of the number of chips simultaneously taking the measurement) or other.

In this configuration, measurement of Ωz is also possible applying a particular sequence of direct currents and/or the magnetic field and/or microwave fields, the topology of the chip array being adapted whenever necessary.

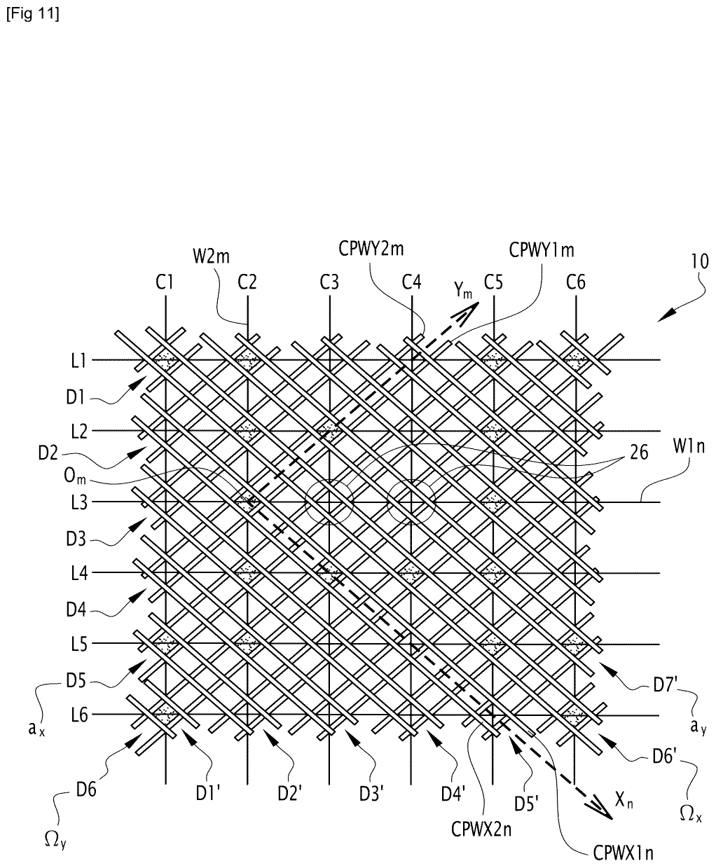

Another example of the arrangement of the chip array 12 is described with reference to FIG. 11.

This arrangement also corresponds to a 6×6 array of elementary chips 26.

In this arrangement, the waveguides 28 form the diagonals, numbered D1 to D6, then D1′ to D6′. The rows and columns are formed by the wires 30 denoted W1n and W2m.

Some elementary chips 26 of the South-West/North-East diagonal D5 measure acceleration ax along X, while some elementary chips 26 of diagonal D6 measure the rotational speed 2y about axis Y.

Some elementary chips 26 of the diagonal South-East/North-West D6′ measure the rotational speed Ωx about axis X, while the elementary chips 26 of the diagonal South-East/North-West D7′ measure acceleration ay along Y.

Therefore, the elementary chips 26 that are encircled are not used for the same reasons as previously.

According to yet another geometry, the trajectories are formed along the three axes by means of additional pairs of waveguides and a splayed conductive wire defining a plane DC. Particular sequences of microwave signals are applied to the different pairs, including signals at pulse ωₐ, or pulse ω_{b}, and signals including both pulses giving a signal denoted ωₐ+ω_{b} and called [symbol] sum [symbol] signal.

One effect of applying a [symbol] sum [symbol] signal (signal derived from the sum of a signal at pulse ωₐ and a signal at pulse ω_{b}) is to repel the two clouds to the side opposite the side containing the guide in which this signal is circulating, to form a trajectory for measuring a rotational speed about axis Z.

It is also possible to use this arrangement for passing from a height h1 to a height h2, when two guides arranged either side of the clouds simultaneously receive the [symbol] sum [symbol] signal, to form trajectories for measuring a rotational speed about axes X and Y.

A still further geometry of the chip array 12 may be based on two secant conductive strips having an intersection contained at least in part within the parallelogram defined by the two pairs of waveguides.

The trajectories are then obtained by applying a specific sequence of microwave signals to the guides, also using the [symbol] repelling [symbol] effect of [symbol] sum [symbol] signals.

Each of the preceding array arrangements allows the forming on one and the same chip of the clock function, measurement of acceleration along two orthogonal axes, and measurement of angular velocities along three orthogonal axes two-by-two.

These arrangements also allow duplication of the elementary geometry on one same atomic chip 12, to carry out all the aforementioned measurements in parallel and implement redundancy between the different measurements, or to perform supplementary measurements.

The atomic chip 12 is therefore an assembly of waveguides 28 and conductive elements (herein wires 30) arranged to allow inertial sensor operation.

The atomic chip 12 is placed in a vacuum chamber 32.

The vacuum chamber 32 maintains a vacuum environment allowing limiting of collisions between trapped cold atoms and the environment.

The vacuum chamber 32 includes for example an ion pump 34 and magnetic shielding 36.

In the atomic chip 12, the number of inertial sensors 14 is advantageously higher than 7.

As previously explained, each sensor 14 of the assembly is an interferometric sensor configured to measure a physical magnitude by applying an interferometry sequence.

The performing of the interferometry sequence causing the sensor 14 to:
generate an initial trapping potential of a cloud of ultracold atoms,
spatially split the cloud trapped in the initial potential into a first cloud of ultracold atoms in a first state and a second cloud of ultracold atoms in a second state via the respective forming of a first atom trap for the first cloud and a second atom trap for the second cloud, and
displacing the formed traps along a respective trajectory for the first cloud and second cloud.

With particular reference to FIGS. 2 and 7, the trajectory depends on the type of measurement performed by the sensor 14.

The atom generating device 16 is configured to generate the cloud of ultracold atoms.

The atom generating device 16 is spatially arranged so that the cloud of ultracold atoms is trapped by the initial trapping potential.

For this purpose, according to the example in FIG. 1, the atom generating device 16 includes an atom dispenser 38 and an atom trap 40.

The atom dispenser 38 allows the dispensing of atoms towards the chip 12.

As an illustration, the atom dispenser 38 is a heating filament delivering a vapor of rubidium.

The atom trap 40 is a trap allowing cooling of the atoms dispensed by the atom dispenser 38 and accordingly provides the cloud of cold atoms.

The atom trap 40, depending on cases, is a magnetic trap, an optical trap or a magneto-optical trap.

The homogeneous magnetic field generator 18 ensures the presence of a homogeneous and stationary magnetic field over a certain thickness above the measurement plane of the atomic chip 12.

Advantageously, the direction of the homogeneous magnetic field is parallel to the measurement plane.

The homogeneous magnetic field generator 18 is an assembly of two Helmholtz coils for example, the current circulating in the coils being controlled by a current generator.

The powering device 20 is configured to apply microwave signals to the waveguides 28 and direct currents to the conductive elements.

In the described example, the powering device 20 includes a microwave generator 42 and a direct current generator 44.

These two generators 42 and 44 are connected to the waveguides 28 and to the conductive elements to inject the appropriate signal (microwave or direct current signal).

The processing unit 22 applies a respective interferometry sequence to each sensor 14 by instructing the homogeneous magnetic field generator 18 and the powering device 20.

The processing unit 22 is typically a computer.

In the described example, the processing unit 22 is additionally configured to apply a respective interferometry sequence to each sensor of a sub-assembly of sensors 14, the sub-assembly of sensors 14 performing the same measurement.

For example, for a measuring system 10 that is an inertial unit, several sub-assemblies of sensors 14 are controlled by the processing unit 22 to carry out several measurements.

For each sub-assembly, the implementing of the respective interferometry sequences by the sub-assembly of sensors 14 causes the sensors 14 of the sub-assembly to measure the same physical magnitude following a trajectory when displaced varying, from one sensor 14 of the sub-assembly to another sensor 14 of the sub-assembly, by at least one parameter related to the trajectory.

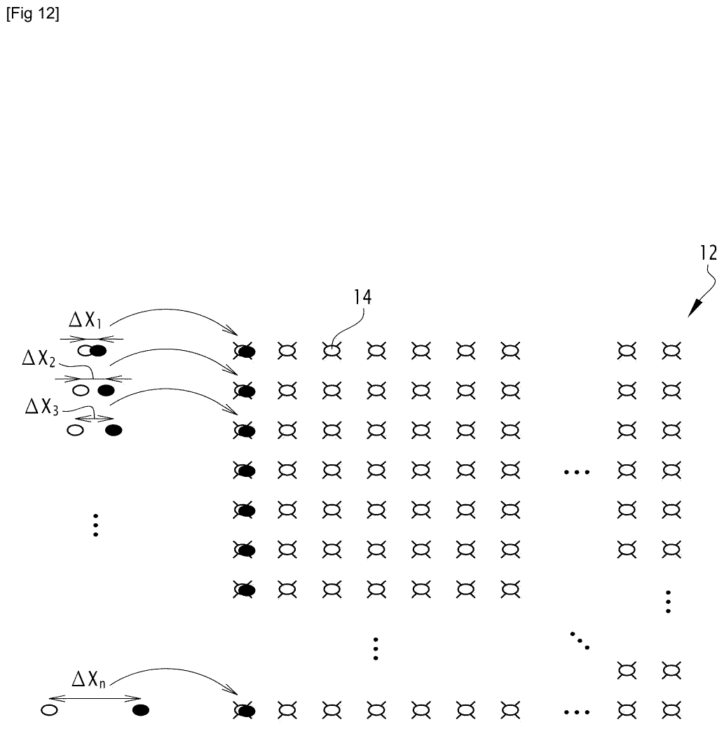

For example, in the example in FIG. 12, the sensors 14 of the first column C1 are used as accelerometers.

In this case, the distance separating the clouds varies from one sensor 14 of the first column C1 to another.

From a material viewpoint, this means that the powers injected into the waveguides vary from one sensor 14 of the first column C1 to another.

In another case, it is the duration of separation T_{S} which varies from one sensor of the first column C1 to another.

This is obtained by varying the total implementation time of steps C0 and D0.

As previously explained, the difference in position Δx and duration of separation T_{S} allow the sensitivity value S of an accelerometer to be varied. By varying these parameters related to the trajectories followed by the traps, the processing unit 22 is provided with several measurements of the same physical magnitude performed at different sensitivities.

Similar remarks apply to the case in which the sensors 14 of the first column C1 are used as gyroscopes.

In a first example, the area of the trajectory formed by the traps is reduced.

Several techniques allow the obtaining of a reduction in the surface area of a trajectory.

For example, it is possible to reduce the amplitude of the microwave currents injected into each waveguide CPW1 and CPW2. This has the effect of reducing the separation distance, and hence the area of the trajectory.

It is also possible to reduce the altitude h2 of the clouds by reducing the amplitude of the bias magnetic field Bc applied after separation of the clouds, to obtain the same effect.

In another example, the number of turns (number of times the

trajectories are travelled by the traps) is reduced by only implementing the sequence in FIG. 7 a reduced number of times.

As previously explained, the area ∥A∥ of the space delimited by the trajectories and the number of turns N allow variation in the value of the sensitivity S of a gyroscope so that, by varying one parameter of the trajectory followed by the traps, the processing unit 22 is provided with several measurements performed with different sensitivities.

The above description may easily be transposed to obtain clocks having variable resolution. In this case, the interferometry sequence entails the application of two identical pulses π/2 but separated in the time of T_{R}. The sensitivity may therefore be modified by varying T_{R} from one sensor to another.

The application of sequences of same type differing by at least one parameter of the trajectory followed by the traps allows several measurements to be obtained of the same magnitude with different sensitivities.

To detect the phases resulting from implementation of the interferometry sequences, the measuring system 10 includes a detection device typically of an optical intensity, adapted to measure at least one population of ultracold atoms of an internal state, this measurement allowing determination of the phase difference between the two states |a [symbol] and |b [symbol] and hence determination of the physical magnitude to be measured.

When in operation, the measuring system 10 applies a measuring method for example.

The measuring method includes application by the processing unit 22 of an interferometry sequence to several sub-assemblies of sensors 14.

More specifically, for each physical magnitude to be measured, the processing unit 22 selects a sub-assembly of sensors 14 to carry out the measurement, and sends an interferometry sequence so that each sensor 14 measures the physical magnitude at a respective sensitivity.

The resolutions of the sensors are chosen so that the measuring ranges are not superimposed but complete each other.

For an illustration thereof, a description is now given of an example for an accelerometer with 3 sensors (sensor 0, sensor 1 and sensor 2), the transposing towards other cases being direct.

To choose the resolution of sensor 0, it is assumed that the maximum value is known of the accelerations it is desired to measure, it is denoted αₘₐₓ. Also denoted is: β₀=mΔz₀T_{R}_{₀}/ℏ, β₀ (hence the pair Δz₀ and T_{R}_{₀}) which is chosen such that:

$${β}_{0} {a}_{max} < απ$$

with α being a coefficient of between 0 and 1, chosen as a function of measurement noises. The total phase of sensor 0 is then:

$${φ}_{tot}^{0} = {β}_{0} {a}_{0}$$

$${φ}_{tot}^{0}$$

is broken down into two parts:

$${φ}_{tot}^{0} = {φ}_{mes}^{0} + {k}_{0} \times π = {β}_{0} {a}_{0}$$

where:
   k₀ by definition is 0.

$${φ}_{tot}^{0}$$

is the total phase accumulated by the sensor, and

$${φ}_{mes}^{0}$$

is the accessible part when measuring populations and is between 0 and π on account of inversion of the cosine.

When measuring

$${φ}_{mes}^{0}$$

an error

$${δφ}_{mes}^{0}$$

is made, corresponding to error δα₀ on acceleration:

$${δφ}_{mes}^{0} = {β}_{0} δ {a}_{0}$$

For the case of sensor 1, the total phase is:

$${φ}_{tot}^{1} = {φ}_{mes}^{1} + {k}_{1} π = {β}_{1} {a}_{1}$$

where:
   α₁ is α₀ but with better resolution.
   k₁ is estimated with the measurement of the preceding sensor:

$${k}_{1} = E [ \frac{{β}_{1} {a}_{0}}{π} ]$$

where E[X] is the whole part of X.
   β₁ is chosen as a function of

$${δφ}_{mes}^{0}$$

β₀.

It may therefore be shown that the following condition must be heeded:

$$\frac{π}{{β}_{1}} > δ {a}_{0} = \frac{{δφ}_{mes}^{0}}{{β}_{0}}$$

The following will therefore be used:

$$\frac{π}{{β}_{1}} = \frac{1}{α} \frac{{δφ}_{mes}^{0}}{{β}_{0}}$$

$$i . e . ,$$

$${β}_{1} = \frac{απ}{{δφ}_{mes}^{0}} {β}_{0}$$

When measuring

$${φ}_{mes}^{1}$$

an error

$${δφ}_{mes}^{1}$$

is made, corresponding to error δα₁ on acceleration:

$${δφ}_{mes}^{1} = {β}_{1} δ {a}_{1}$$

Similarly, for sensor 2, the total phase is:

$${φ}_{tot}^{2} = {φ}_{mes}^{2} + {k}_{2} π = {β}_{2} {a}_{2}$$

where:
   α₂ is α₁ but with better resolution.
   k₂ is estimated with the measurement of the preceding sensor:

$${k}_{2} = E [ \frac{{β}_{2} {a}_{0}}{π} ]$$

β₂ is chosen as a function of

$${δφ}_{mes}^{1}$$

and β₁.

It may then be shown that the following condition must be heeded:

$$\frac{π}{{β}_{2}} > δ {a}_{1} = \frac{{δφ}_{mes}^{1}}{{β}_{1}}$$

The following will therefore be used:

$$\frac{π}{{β}_{2}} = \frac{1}{α} \frac{{δφ}_{mes}^{1}}{{β}_{1}}$$

$$i . e . ,$$

$${β}_{1} = \frac{απ}{{δφ}_{mes}^{1}} {β}_{1} = \frac{{( απ )}^{2}}{{δφ}_{mes}^{1} {δφ}_{mes}^{0}} {β}_{0}$$

When measuring

$${φ}_{mes}^{2}$$

an error

$${δφ}_{mes}^{2}$$

is made, corresponding to an error δα₂ on acceleration:

$${δφ}_{mes}^{2} = {β}_{2} δ {a}_{2}$$

Therefore, by generalizing this reasoning for a sensor n, sensitivity will be obtained by means of the following formula:

$${β}_{n + 1} = \frac{{( απ )}^{n}}{{\prod }_{i = 0}^{n} {δφ}_{mes}^{i}} {β}_{0}$$

The number of sensors of a sub-assembly is chosen to be between 2 and 30.

The method then includes implementation of the interferometry sequence by each of the sensors 14 of the sub-assembly under consideration.

Preferably, the interferometry sequences are implemented simultaneously (same starting times).

Thereafter, the processing unit 22 collects all the measurements and processes the same to obtain a measurement of the physical magnitude under consideration.

The proposed method therefore allows the extending of the range of measurement of each measured inertial physical magnitude.

This also provides the benefit of measurement redundancy of one same parameter by several sensors, some of which operate with deliberately degraded sensitivity.

The method presented herein affords the possibility of extending range of measurement without undermining sensitivity.

This makes it possible to reduce errors on determination of measurement.

The method is easy to implement insofar as it is not dependent on the specific architecture of the measuring system 10.

It may therefore be used under embedded conditions.

In addition, the geometry of the sub-assembly is not limiting, the column arrangement in FIG. 12 is not compulsory.

Any combination of parameter modifications may be envisaged relating to the trajectory followed by the traps.

For example, for an accelerometer, if relevant, both the separation distance Δx and the duration of separation T_{S} may be varied, to obtain a wider variety of sensitivity values.

1. An ultracold atom measuring system, comprising:
an assembly of ultracold atom inertial sensors, each sensor of the assembly being an interferometric sensor measuring a physical magnitude by implementing an interferometry sequence that causes the sensor to:
generate an initial trapping potential of a cloud of ultracold atoms,
spatially split the cloud trapped in the initial potential into a first cloud of ultracold atoms in a first state and a second cloud of ultracold atoms in a second state via the respective forming of a first atom trap for the first cloud and a second atom trap for the second cloud, and
displace the formed traps along a respective trajectory for the first cloud and second cloud; and
a processing unit applying, for each of at least one sub-assembly of sensors, a respective interferometry sequence to each sensor of the sub-assembly of sensors, wherein implementing the respective interferometry sequences by the at least one sub-assembly of sensors causes the sensors of the sub-assembly to measure the same physical magnitude, and wherein the trajectory followed when displacing the formed traps varies from one sensor of the sub-assembly to another sensor of the sub-assembly, by at least one parameter related to the trajectory.

2. The measuring system according to claim 1, wherein at least one sub-assembly of sensors is able to measure an acceleration, at least one parameter related to the trajectory being a separation distance between the two traps.

3. The measuring system according to claim 1, wherein at least one sub-assembly of sensors is able to measure an acceleration, at least one parameter related to the trajectory being the travel time of the trajectory.

4. The measuring system according to claim 1, wherein at least one sub-assembly of sensors is able to measure an angular velocity, at least one parameter related to the trajectory being the surface area delimited by the trajectory.

5. The measuring system according to claim 1, wherein at least one sub-assembly of sensors is able to measure an angular velocity, at least one parameter related to the trajectory being the number of times the trajectory is travelled.

6. The measuring system according to claim 1, wherein said assembly of sensors is formed on one same atomic chip placed in a vacuum chamber and comprising waveguides and conductive elements.

7. The measuring system according to claim 6, further comprising:
an atom generating device generating an initial cloud of ultracold atoms;
a generator of a homogeneous magnetic field; and
a powering device comprising:
at least one microwave generator; and
at least one direct current generator, the powering device applying microwave signals to the waveguides and direct currents to the conductive elements,
wherein said processing unit applies a respective interferometry sequence to each sensor of the at least one sub-assembly of sensors by controlling the homogeneous magnetic field generator and the powering device.

8. The measuring system according to claim 1, wherein said processing unit applies a respective interferometry sequence to each sensor of several sub-assemblies of sensors, causing the sensors of the sub-assembly to measure the same physical magnitude following a trajectory when displacing the formed traps varying, from one sensor of the sub-assembly to another sensor of the sub-assembly, by at least one parameter related to the trajectory, the measured physical magnitude differing from one sub-assembly to another.

9. The measuring system according to claim 1, wherein the number of sensors of a sub-assembly is between 2 and 30.

10. A method to measure a physical magnitude with an ultracold atom measuring system, the measuring system comprising an assembly of ultracold atom inertial sensors, each sensor of the assembly being an interferometric sensor measuring a physical magnitude by implementing an interferometry sequence, and a processing unit, the method comprising applying, by the processing unit, for each of at least one sub-assembly of sensors, a respective interferometry sequence to each sensor of the sub-assembly of sensors, causing the sensors of the sub-assembly to:
generate an initial trapping potential of a cloud of ultracold atoms;
spatially split the cloud trapped in the initial potential into a first cloud of ultracold atoms in a first state and a second cloud of ultracold atoms in a second state via the respective forming of a first atom trap for the first cloud and a second atom trap for the second cloud;
displace the formed traps along a respective trajectory for the first cloud and second cloud; and
measure the same physical magnitude following a trajectory when displacing the formed traps varying, from one sensor of the sub-assembly to another sensor of the sub-assembly, by at least one parameter related to the trajectory.
